(19) United States
(12) Patent Application Publication
(10) Pub. No.: US 2025/0190181 A1
(43) Pub. Date: Jun. 12, 2025

(54) DIGITAL LEARNING CONTENT AUTHORING TOOL ADAPTED FOR NON-TECHNICAL AUTHORS

(71) Applicant: Hewlett Packard Enterprise Development LP, Spring, TX (US)

(72) Inventors: Lance Taylor, Spring, TX (US); David Mathevet, Saint-Priest (FR)

(21) Appl. No.: 18/419,887

(22) Filed: Jan. 23, 2024

(30) Foreign Application Priority Data
Dec. 12, 2023 (EP) 23307187.7

(51) Int. Cl. G06F 8/34; G06F 8/38; G09B 7/04

(52) U.S. Cl. CPC G06F 8/34; G06F 8/38; G09B 7/04

(57) ABSTRACT

Examples of the presently disclosed technology provide digital learning systems that integrate an innovative learning authoring tool tailored for non-technical authors with front-end learning content software that natively performs textured/granular evaluation of a learner's progress, and dynamically modifies the digital learning content presented to the learner in response to such textured/granular evaluation.

### BACKGROUND

Learning authoring tools are software programs/platforms that allow users to create and customize digital learning content (sometimes referred to as “e-learning” content). Digital learning content may include digital learning courses or digital lessons comprised of text, audio, video, games, tests, and other types of digital learning content.

Front-end learning content software can be used to present/display (created) digital learning content and receive inputs from learners as the learners engage with the digital learning content. Such front-end learning content software can present the digital learning content via the internet (e.g., via a web browser interface), via installed/downloaded software applications, or in other digital forms.

In many cases, learning authoring tools and/or front-end learning content software will communicate (or otherwise integrate) with a back-end learning management system (LMS) that helps administrate and deliver digital learning content. For example, an LMS may document, track, and report a learner's progress through a digital learning course.

As used herein “front-end” software may refer to software that presents content to users, and receives user inputs. Such “front-end” software is sometimes associated with the presentation layer of the OSI model of computer networking. As used herein, “back-end” software may refer to software associated with a data access layer that provides access to data stored in persistent memory/storage. In a traditional client-server model, front-end software is associated with the client and back-end software is associated with the server.

### BRIEF DESCRIPTION OF THE DRAWINGS

The present disclosure, in accordance with one or more various examples, is described in detail with reference to the following figures. The figures are provided for purposes of illustration only and merely depict examples.

FIG. 1A illustrates an example environment for implementing an example digital learning system, in accordance with various examples of the presently disclosed technology.

FIGS. 1B-1C depict the example digital learning system from FIG. 1A, and illustrate how the digital learning system can be used to create digital learning content and evaluate a learner's progress, in accordance with various examples of the presently disclosed technology.

FIGS. 2A-2G depict example displays from an author-side graphical user interface (GUI) of a digital learning system of the presently disclosed technology.

FIG. 3 depicts an example display from a learner-side GUI of a digital learning system of the presently disclosed technology.

FIG. 4 depicts another example display from a learner-side GUI of a digital learning system of the presently disclosed technology.

FIG. 5 depicts an example learner progress report, in accordance with various examples of the presently disclosed technology.

The figures are not exhaustive and do not limit the present disclosure to the precise form disclosed.

### DETAILED DESCRIPTION

While existing digital learning technologies (e.g., existing learning authoring tools, existing front-end learning content software, existing back-end learning management systems (LMSs), and other types of digital learning-related tools/software) can be useful for creating, presenting, and administrating digital learning content, they can be limited in certain areas.

For example, back-end LMSs are typically provisioned by separate vendors from the learning authoring tools used to create digital learning content and the front-end learning content software that presents the (created) digital learning content to learners. Accordingly, certain features/functionalities that a learning authoring tool vendor may want to provide to authors will be restricted by requisite adherence to an LMS vendor's protocols/back-end system. For example, a learning authoring tool vendor may want to build a tool that allows for more textured/granular evaluation of a learner's progress through a digital learning course. However, these desired features/functionalities may not be supported by existing protocols of LMS vendors-thereby frustrating the learning authoring tool vendor's attempts at innovation.

As a related example, existing digital learning technologies typically rely on a back-end LMS for evaluating a learner's progress as the learner interacts with digital learning content via front-end learning content software. For example, many existing digital learning technologies report a learner's interactions received via front-end learning content software to a back-end LMS. The back-end LMS evaluates the learner's progress based on the reported learner interactions, and then reports the evaluated learner progress back to the front-end learning content software where it can be displayed to the learner. This conventional learner progress evaluation approach has a few disadvantages. For example, if a learning authoring tool vendor wants to build a tool that allows for more textured/granular evaluation of leaner progress-such features/functionalities may not be supported by existing protocols of LMS vendors. Relatedly, reliance on a back-end LMS for evaluating learner progress can make it difficult/infeasible to dynamically modify the digital learning content presented to a learner in response to the learner's evaluated progress. Accordingly, the learner may derive less value from the digital learning content than would be the case if the digital learning content was dynamically modified/tailored to the learner's learning experience. There can also be data latency (and related inefficiencies) associated with a front-end learning content software having to report a learner's interactions to a back-end LMS, the back-end LMS evaluating the learner's progress based on the reported learner interactions, and the back-end LMS then having to report the evaluated learner progress back to the front-end learning content software. Potentially due to the above-described inefficiencies, existing digital learning technologies typically only evaluate learner progress at the end of a digital learning course. Accordingly, a learner may derive less value from the digital learning course than would be the case if the learner received more frequent/granular feedback on their progress.

Another limitation/drawback of existing digital learning technologies is a barrier-to-entry for non-technical authors who want to create digital learning content. Namely, creating digital learning content using existing learning authoring tools typically requires a certain level of coding experience/expertise-which many non-technical authors do not have. Accordingly, such non-technical authors may need to hire (or otherwise work with) an individual with coding experience/expertise in order to create desired digital learning content-which can increase development costs. Relatedly, there may be a relative scarcity of digital learning content involving non-technical subject matter as prospective authors in these fields may be discouraged from creating digital learning content due to their lack of requisite coding experience/expertise.

Against this backdrop, examples of the presently disclosed technology provide digital learning systems that integrate an innovative learning authoring tool tailored for non-technical authors with front-end learning content software that natively performs textured/granular evaluation of a learner's progress, and dynamically modifies the digital learning content presented to the learner in response to such textured/granular evaluation.

For example, a digital learning system of the presently disclosed technology may comprise an author-side graphical user interface (GUI) configured to receive low code inputs defining: (a) terminal objectives for a digital learning course; (b) enabling objectives for the digital learning course; (c) weighted associations between respective terminal objectives and respective subsets of enabling objectives that guide learners toward the respective terminal objectives; and (d) content pages for arranging digital learning content for the enabling objectives. The digital learning system may further comprise one or more processing resources operative to execute machine-readable instructions to: (i) based on low code inputs received via the author-side GUI, create the digital learning course having the defined terminal objectives, the defined enabling objectives, the defined weighted associations between respective terminal objectives and respective subsets of enabling objectives, and the defined content pages; and (ii) provide the created digital learning course to learners via a learner-side GUI. The digital learning system may also comprise the learner-side GUI configured to display the created digital learning course and receive inputs from learners as the learners engage with the created digital learning course.

Responsive to receiving a learner's inputs via the learner-side GUI, the one or more processing resources may be further operative to execute machine-readable instructions to: (iii) compute, for enabling objectives of a first subset of enabling objectives associated with a first terminal objective, a progress score and a performance score for the learner's progress towards the enabling objective; (iv) based on the defined weighted associations between the first terminal objective and the first subset of enabling objectives, compute a performance score for the learner's progress towards the first terminal objective as a weighted sum of the computed performance scores for the learner's progress towards the first subset of enabling objectives; and (v) based on the defined weighted associations between the first terminal objective and the first subset of enabling objectives, compute the performance score for the learner's progress towards the first terminal objective as a weighted sum of the computed performance scores for the learner's progress towards the first subset of enabling objectives. Responsive to at least one of the computed progress score and the computed performance score for the learner's progress towards the first terminal objective, the one or more processing resources may be further operative to execute machine-readable instructions to: (vi) modify content of the digital learning course provided to the learner; and/or (vii) transmit, to a back-end LMS, records related to the computed progress score and the computed performance score for the learner's progress towards the first terminal objective.

Particular features of the above-described digital learning system are described in greater detail below.

### Author-Side GUI and Low Code Inputs

As used herein, low code may refer to software development approaches that help developers/authors create software applications with minimal hand coding. Low code approaches typically utilize a GUI that allows a developer to create software through intuitive inputs/commands such as drag-and-drop-related inputs, pull-down-menu-related inputs, point-and-click-related inputs, and other types of low code inputs. Leveraging an author-side GUI configured to receive low code inputs, the digital learning system of the presently disclosed technology is specially adapted for use by non-technical authors (e.g., authors lacking hand-coding expertise). By removing the conventional barrier-to-entry for prospective non-technical authors of digital learning content, examples can reduce development costs and increase the amount and variety of digital learning content available to learners.

### Terminal Objectives and Enabling Objectives

As used herein, a terminal objective may refer to an author-defined desired outcome for learners engaging with a digital learning course. An enabling objective may refer to an author-defined learning experience that guides learners to one or more terminal objectives.

As an illustrative example, an author may want to create a digital learning course that teaches learners (who in this specific example also happen to be prospective digital learning content authors) how to use the digital learning system of presently disclosed technology-sometimes referred to herein as “DLS.” Examples of author-defined terminal objectives for this digital learning course may comprise: (1) “Observe the DLS interface and recognize the required components;” (2) “Identify the DLS static components;” (3) “Find the DLS interactive components;” (4) “Locate the DLS-branded visual components;” and (5) “Explain the DLS advanced components.” Examples of author-defined enabling objectives that guide learners to the first terminal objective (i.e., “Observe the DLS interface and recognize the required components”) may include: (a) “Indicate the two methods for creating the skeleton of a content page;” and (b) “Identify usage of the DLS scripts.” The digital learning system can receive low code inputs defining these terminal objectives and enabling objectives via the author-side GUI. The weighted associations between the terminal objectives and enabling objectives are described in greater detail further in the description. The digital learning system can also receive low code defining content pages (e.g., web pages or segments of web pages) for arranging digital learning content (e.g., descriptive text, audio, video, activities, tests, and other types of digital learning content) for the enabling objectives of the digital learning course. The digital learning system can then automatically create the digital learning course having these defined terminal objectives, enabling objectives, and content pages.

### Textured/Granular Evaluation of Learning Progress and Weighted Associations Between Terminal Objectives and Enabling Objectives

The digital learning system can help authors create digital learning courses that evaluate learner progress in a more textured/granular way. The above-described terminal objectives and enabling objectives can be useful for realizing this functionality.

Using the author-side GUI of the digital learning system, an author can create a digital learning course that evaluates a learner's progress against terminal and enabling objectives. For example, an author can provide low code inputs defining weighted associations between a first terminal objective and a first subset of enabling objectives that guide learners towards the first terminal objective. Responsive to a learner's interactions with the digital learning course, the digital learning system can then compute a progress score and a performance score for enabling objectives of the first subset of enabling objectives. Based on the defined weighted associations between the first terminal objective and the first subset of enabling objectives, the digital learning system can then compute a progress score for the first terminal objective as a weighted sum of the computed progress scores of the first subset of enabling objectives. Relatedly, the digital learning system can compute a performance score for first terminal objective as a weighted sum of the computed performance scores of the first subset of enabling objectives. Computed progress and performance scores for the terminal objectives and enabling objectives respectively can provide the learner (and/or an administrator overseeing the learner's progress) with frequent and textured/granular feedback on progress-which can increase the value the learner derives from the digital learning course.

### Native Learning Progress Computation and Dynamic Modification of Digital Learning Content

Conventional digital learning systems typically rely on a back-end LMS to evaluate learner progress. Such reliance can frustrate efforts, like those described above, to evaluate learner progress in more textured/granular ways than would be supported by existing protocols of LMS vendors. Relatedly, there can be data latency (and related inefficiencies) associated with a front-end learning content software having to report a learner's interactions to a back-end LMS, the back-end LMS evaluating the learner's progress based on the reported learner interactions, and the back-end LMS then having to report the evaluated learner progress back to the front-end learning content software. Potentially due to the above-described inefficiencies, existing digital learning technologies typically only evaluate learner progress at the end of a digital learning course. Accordingly, a learner may derive less value from the digital learning course than would be the case if the learner received more frequent/granular feedback on their progress. Moreover, reliance on a back-end LMS for evaluating learner progress can make it difficult/infeasible to dynamically modify the digital learning content presented to a learner in response to the learner's progress. Accordingly, the learner may derive less value from the digital learning content than would be the case if the digital learning content was dynamically modified/tailored to the learner's learning experience.

By natively computing learner progress on the front-end, and by result, not relying on a back-end LMS to perform such computation/evaluation, the digital learning system of the presently disclosed technology resolves the drawbacks of conventional digital learning systems described above. For example, without being gated behind a separate LMS vendor's existing protocols, the digital learning system can enable an innovative digital learning course construction approach that evaluates a learner's progress against a series of terminal and enabling objectives. Such learner progress computation can be rapid, dynamic, and frequent-due in part to reduced data latency (and a reduction in related inefficiencies) associated with a reduction in back-and-forth communication between front-end learning content software and a back-end LMS. Relatedly, because learner progress computation is performed on the front-end, the digital learning system can more feasibly, and dynamically modify digital learning content in response to computed learner progress. This allows for more tailored/individualized content based on a specific learner's experience, which can increase the value the leaner derives from the digital learning course.

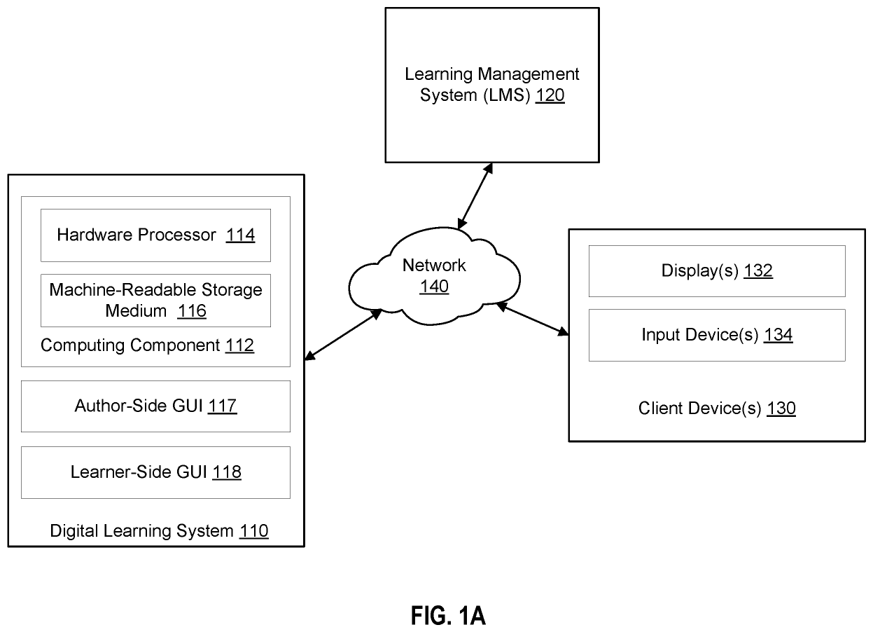

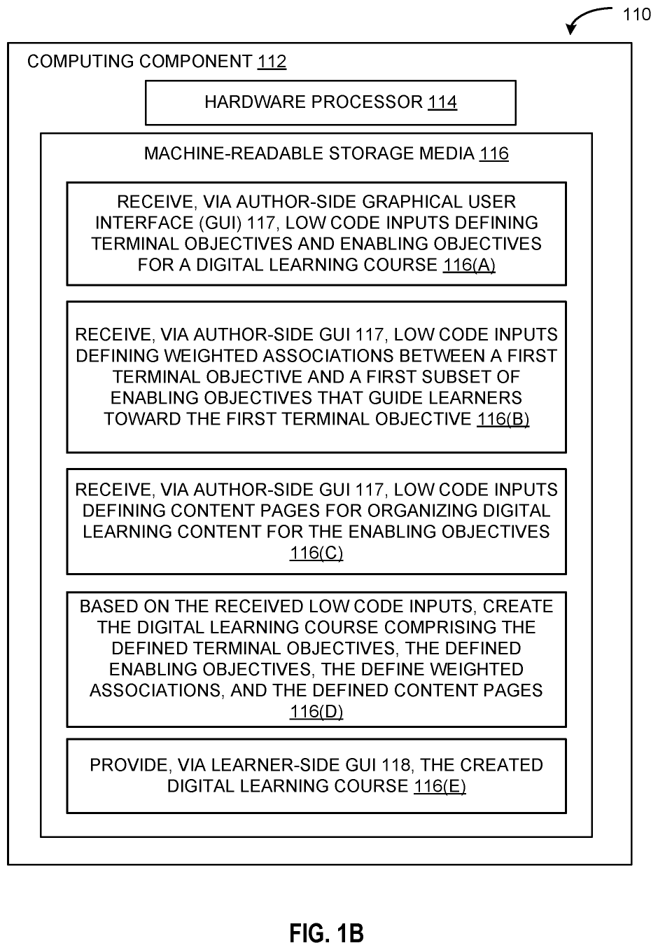

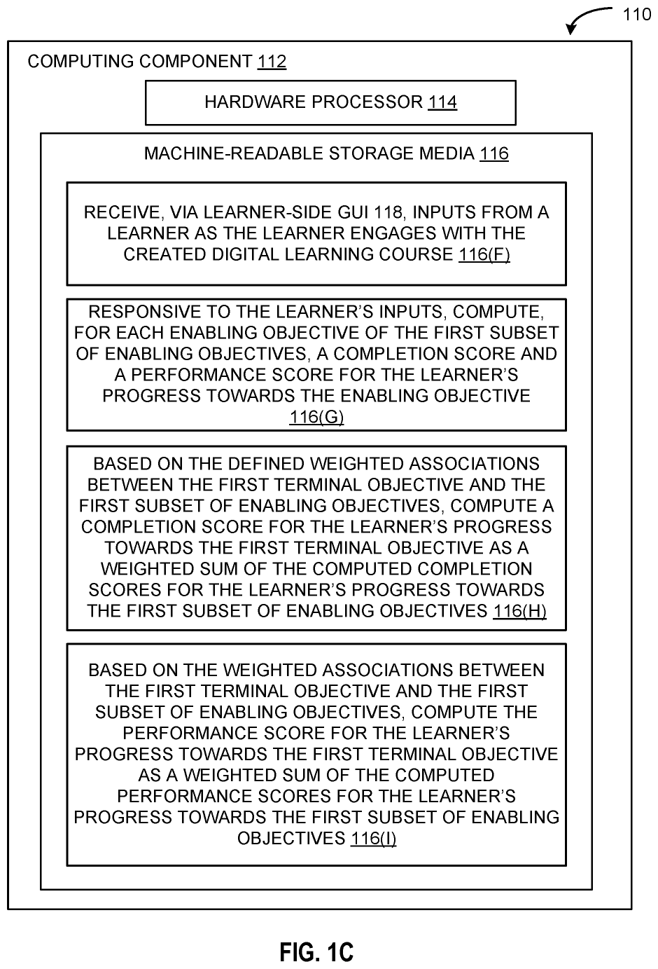

FIG. 1A illustrates an example environment for implementing an example digital learning system 110, in accordance with various examples of the presently disclosed technology.

As depicted, digital learning system 110 may communicate with an LMS 120 and client device(s) 130 via a network 140.

Before describing FIG. 1A in more detail, it should be understood that FIG. 1A depicts a specific example of a “cloud computing” environment where digital learning system 110 is provided over a network (i.e., network 140) as “software as a service” (SaaS). However, in other implementations digital learning system 110 (and/or front-end components of digital learning system 110) may be downloaded/installed onto client device(s) 130, or otherwise accessed/utilized by client device 130 (s) in a different manner.

Referring now to FIG. 1A, network 140 may be a public or private network, such as the Internet, or other communication network to allow connectivity among various systems and devices, such as digital learning system 110, LMS 120, and client device 130 (s). Network 140 may include third-party telecommunication lines, such as phone lines, broadcast coaxial cable, fiber optic cables, satellite communications, cellular communications, and the like. Network 140 may also include any number of intermediate network devices, such as switches, routers, gateways, servers, and/or controllers that facilitate communication between network-connected entities.

Client device(s) 130 may comprise one or more client devices associated with prospective author(s) of digital learning content and/or learners engaging with digital learning content.

Examples for client device 130 (s) may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IoT) devices, and the like.

As depicted, client device(s) 130 may comprise display(s) 132 and input device(s) 134. In some examples, display(s) 132 and input device(s) 134 may be connected to each other and with other components of client device(s) 130 (e.g., processors and memory which are not depicted) via a bus or other communication mechanism.

Display(s) 132 may comprise one or more displays (e.g., liquid crystal displays, touch screen displays, or other types of displays) for displaying information to users of client device(s) 132. For example, display(s) 132 can display/present one or more of an author-side GUI 117 and a learner-side GUI 118 of digital learning system 110 to users.

Input device(s) 134 may comprise one or more devices (e.g., keyboards, cursor control such as a mouse or track ball, or other types of input devices for computers) that allow a user of client device(s) 132 to provide inputs (e.g., point-and-click-related inputs, drag-and-drop-related inputs, pull-down-menu-related inputs, descriptive text-entering-inputs, and other types of inputs). For example input device(s) 134 can allow a user of client device(s) 132 to provide inputs to digital learning system 110 via one or more of author-side GUI 117 and learner-side GUI 118. In some examples (e.g., where display(s) 132 comprise touch screen displays), input device(s) 134 may overlap with display(s) 132.

LMS 120 may comprise a back-end software system that helps administrate and deliver digital learning content (e.g., document, track, and report a learner's progress through a digital learning course). Conventionally LMS 120 would be used to evaluate a learner's progress through a digital learning course. However, in accordance with the presently disclosed technology, such evaluation logic can be handled by digital learning system 110. Accordingly, digital learning system 110 may rely on LMS 120 for a more limited array of functions, such as storing learning records for individual learners. For example, digital learning system 110 can transmit, via network 140, records related to computed progress scores and computed performance scores for a learner's progress towards terminal objectives and/or enabling objectives of a digital learning course. Digital learning system 110 can also access records related to a learner's progress/performance in various digital learning courses from LMS 120.

In the specific example of FIG. 1A digital learning system 110 is provided over a network (i.e., network 140) as “software as a service” (SaaS). However, in other examples digital learning system 110 (and/or front-end components of digital learning system 110) may be downloaded/installed onto client device 130 (s), or otherwise accessed/utilized by client device 130 (s) in a different manner.

As depicted in FIG. 1A, digital learning system 110 comprises a computing component 112, an author-side GUI 117, and a learner-side GUI 118.

Author-side GUI 117 and learner-side GUI 118 may be various types of graphical user interfaces (GUIs). In some examples, author-side GUI 117 and learner-side GUI 118 may be stored as executable software codes in a storage device of digital learning system 110 (e.g., machine-readable storage medium 116).

Digital learning system 110 can cause author-side GUI 117 and/or learner-side GUI 118 to be presented via display(s) 132 of client device(s) 130. Relatedly, digital learning system 110 can receive user inputs provided by input devices(s) 134 via author-side GUI 117 and/or learner-side GUI 118.

Computing component 112 may be, for example, a server computer, a controller, or any other similar computing component capable of processing data. In the example implementation of FIGS. 1A-1C, computing component 112 includes a hardware processor 114, and machine-readable storage medium for 116. In examples where digital learning system 110 is downloaded/installed on client device(s) 130, computing component 112 may be implemented on a client device of client device(s) 130.

Hardware processor 114 may be one or more central processing units (CPUs), semiconductor-based microprocessors, and/or other hardware devices suitable for retrieval and execution of instructions stored in machine-readable storage medium 116. Hardware processor 114 may fetch, decode, and execute instructions, such as instructions 116(A)-(I), to control processes or operations for creating digital learning content, delivering digital learning content, computing learner progress, among other things. As an alternative or in addition to retrieving and executing instructions, hardware processor 114 may include one or more electronic circuits that include electronic components for performing the functionality of one or more instructions, such as a field programmable gate array (FPGA), application specific integrated circuit (ASIC), or other electronic circuits.

Machine-readable storage medium, such as machine-readable storage medium 116, may be any electronic, magnetic, optical, or other physical storage device that contains or stores executable instructions. Thus, machine-readable storage medium 116 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 116 may be a non-transitory storage medium, where the term “non-transitory” does not encompass transitory propagating indicators. As described in detail below, machine-readable storage medium 116 may be encoded with executable instructions, for example, instructions 116(A)-(I). Further, although the instructions shown in FIGS. 1B-1C are in an order, the shown order is not the only order in which the instructions may be executed. Any instruction may be performed in any order, at any time, may be performed repeatedly, and/or may be performed by any suitable device or devices.

As depicted, hardware processor 114 can execute instruction 116(A) to receive, via author-side GUI 117, low code inputs defining terminal objectives and enabling objectives for a digital learning course. Author-side GUI 117 may be displayed/presented on one of display(s) 132 of client device(s) 130. In implementations where digital learning system 110 is provided over a network (e.g., network 140), author-side GUI 117 may comprise a web browser GUI presented on one of on one of display(s) 132. The user may provide the low code inputs via input device(s) 134 of client device(s) 130.

As described above, leveraging author-side GUI 117 which is configured to receive low code inputs, digital learning system 110 may be specially adapted for use by non-technical authors (e.g., authors lacking hand-coding expertise). By removing the conventional barrier-to-entry for prospective non-technical authors of digital learning content, digital learning system 110 can reduce development costs and increase the amount and variety of digital learning content available to learners

As described above, a terminal objective may refer to an author-defined desired outcome for learners engaging with a digital learning course. An enabling objective may refer to an author-defined learning experience that guides learners to one or more terminal objectives.

Hardware processor 114 can execute instruction 116(B) to receive, via author-side GUI 117, low code inputs defining weighted associations between a first terminal objective and a first subset of enabling objectives that guide learners toward the first terminal objective. As used herein, a weighted association between a respective terminal objective and a respective enabling objective may comprise a numerical multiplier that is used to compute the performance and progress scores for the respective terminal objective based on the performance and progress scores for the respective enabling objective. For example, the first subset of enabling objectives may comprise a first enabling objective, a second enabling objective, and a third enabling objective. A weighted association between the first terminal objective and the first enabling objective may be 0.2. A weighted association between the first terminal objective and the second enabling objective may be 0.5. A weighted association between the first terminal objective and the third enabling objective may be 0.3. A performance score for the first enabling objective may be 80, a performance score for the second enabling objective of may be 50, and a performance score for the third enabling objective may be 90. Based on the above-described weighted associations and performance scores for the first-third enabling objectives, hardware processor 114 can compute a performance score for the first terminal objective as follows: (0.2)(80)+(0.5)(50)+(0.3)(90)=68. Relatedly, a progress score for the first enabling objective may be 40, a progress score for the second enabling objective of may be 80, and a progress score for the third enabling objective may be 50. Based on the above-described weighted associations and progress scores for the first-third enabling objectives, hardware processor 114 can compute a progress score for the first terminal objective as follows: (0.2)(40)+(0.5)(80)+(0.3)(50)=63.

Hardware processor 114 can execute instruction 116(C) to receive, via author-side GUI 117, low code inputs defining content pages for arranging digital learning content for the enabling objectives. In certain examples the content pages may comprise web pages, or segments of web pages. The digital learning content may comprise various types of digital content such as descriptive text, audio, video, activities/games, tests, and other types of digital learning content.

In certain implementations author-side GUI 117 may comprise: (a) a terminal objective field configured to receive the low code inputs defining terminal objectives for the digital learning course; (b) an enabling objective field configured to receive the low code inputs defining enabling objectives for the digital learning course; and (c) a content page field configured to receive the low code inputs arranging digital learning content for the enabling objectives. In various examples, at least one of the terminal objective field and the enabling objective field may also be configured to receive the low code inputs defining the weighted associations between the first terminal objective and the first subset of enabling objectives.

Based on the low code inputs received through execution of instructions 116(A)-(C), hardware processor 114 can execute instruction 116(D) to create the digital learning course comprising the defined terminal objectives, the defined enabling objectives, the define weighted associations, and the defined content pages. Hardware processor 114 can utilize various types of low code generation tools to convert the low code inputs received via instructions 116(A)-(C) into actual source code that implements the digital learning course. For example if a defined enabling objective includes a quiz hardware processor 114 will generate a component of a GUI corresponding with the quiz.

Hardware processor 114 can then execute instruction 116(E) to provide, via learner-side GUI 118, the created digital learning course. Learner-side GUI 118 may be displayed/presented on one of display(s) 132 of client device(s) 130. In implementations where digital learning system 110 is provided over a network (e.g., network 140), learner-side GUI 118 may comprise a web browser GUI presented on one of display(s) 132.

As depicted in FIG. 1C, hardware processor 114 can execute instruction 116(F) to receive, via learner-side GUI 118, inputs from a learner as the learner engages with the created digital learning course. Such inputs may comprise e.g., the learner playing a video, the learner performing an activity, the learner taking a test/quiz, and other types of inputs. As described above, the learner can provide the inputs using input device(s) 134 of client device(s) 130.

Responsive to the learner's inputs, hardware processor 114 can execute instruction 116(G) to compute, for enabling objectives of the first subset of enabling objectives, a progress score and a performance score for the learner's progress towards the enabling objective. As used herein, a progress score for a respective enabling objective may be a number or related metric that measures a degree/amount to which a learner has completed the respective enabling objective. As used herein, a performance score for the respective enabling objective may be a number or related metric that measures a learner's performance across various activities associated with the respective enabling objective For example, digital learning content for the respective enabling objective may be arranged across three content pages. The first content page may present a 10:00 minute video for the learner to watch. Digital learning system 110 can track how many minutes of the video the learner has watched, and hardware processor 114 can use this information to compute a portion of the progress score for the respective enabling objective. In some examples, hardware processor 114 can also use this information to compute a portion of the performance score for the respective enabling objective (for example, if the learner watches the entire video hardware processor 114 may compute a higher performance score than if the learner only watched a portion of the video). The second content page may present a 10 question quiz based on the video on the first content page. Digital learning system 110 can track how many quiz questions the learner has answered (correctly or incorrectly), and hardware processor 114 can use this information to compute another portion of the progress score for the respective enabling objective. Relatedly, hardware processor 114 compute a portion of the performance score for the enabling objective based on how many questions the learner answered correctly vs. incorrectly. The third content page may present 5 drag-and-drop activities for the learner to complete to assess their understanding of the video on the first content page. Digital learning system 110 can determine how many of the 5 drag-and-drop activities the learner completes, and hardware processor 114 can use this information to compute a portion of the progress score for the respective enabling objective. Relatedly, digital learning system 110 can track how many tries the learner required to complete the 5 drag-and-drop activities (or how many mistakes the learner made before completing the 5 drag-and-drop activities), and hardware processor 114 can use this information to compute a portion of the performance score for the respective enabling objective. Based on the defined weighted associations between the first terminal objective and the first subset of enabling objectives, hardware processor 114 can then execute instruction 116(H) to compute a progress score for the learner's progress towards the first terminal objective as a weighted sum of the computed progress scores for the learner's progress towards the first subset of enabling objectives. For example, the first subset of enabling objectives may comprise a first enabling objective, a second enabling objective, and a third enabling objective. A weighted association between the first terminal objective and the first enabling objective may be 0.2. A weighted association between the first terminal objective and the second enabling objective may be 0.5. A weighted association between the first terminal objective and the third enabling objective may be 0.3. A progress score for the first enabling objective may be 40, a progress score for the second enabling objective of may be 80, and a progress score for the third enabling objective may be 50. Based on the above-described weighted associations and progress scores for the first-third enabling objectives, hardware processor 114 can compute a progress score for the first terminal objective as follows: (0.2)(40)+(0.5)(80)+(0.3)(50)=63. Relatedly (and based on these same weighted associations), hardware processor 114 can execute instruction 116(I) to compute the performance score for the learner's progress towards the first terminal objective as a weighted sum of the computed performance scores for the learner's progress towards the first subset of enabling objectives. For example, a performance score for the first enabling objective may be 80, a performance score for the second enabling objective of may be 50, and a performance score for the third enabling objective may be 90. Based on the above-described weighted associations and performance scores for the first-third enabling objectives, hardware processor 114 can compute a performance score for the first terminal objective as follows: (0.2)(80)+(0.5)(50)+(0.3)(90)=68

Computed progress and performance scores for the terminal objectives and enabling objectives respectively can provide the learner (and/or an administrator overseeing the learner's progress) with frequent and textured/granular feedback on progress-which can increase the value the learner derives from the digital learning course.

Relatedly, by natively computing learner progress on the front-end, and by result, not relying on a back-end LMS (e.g., LMS 120) to perform such computation/evaluation, digital learning system 110 resolves certain drawbacks of conventional digital learning systems. For example, without being gated behind a separate LMS vendor's existing protocols, digital learning system 110 can enable an innovative digital learning course construction approach that evaluates a learner's progress against the terminal and enabling objectives. Such learner progress computation can be rapid, dynamic, and frequent-due in part to reduced data latency (and a reduction in related inefficiencies) associated a reduction in back-and-forth communication between front-end learning content software and a back-end LMS. Relatedly, because learner progress computation is performed on the front-end, digital learning system 110 can more feasibly, and dynamically modify digital learning content in response to computed learner progress. For example, hardware processor 114 can execute a further instruction (not depicted), to modify content of the digital learning course in response to at least one of the computed performance score and the computed progress score for the learner's progress towards the first terminal objective. This allows for more tailored/individualized content based on a specific learner's experience, which can increase the value the leaner derives from the digital learning course.

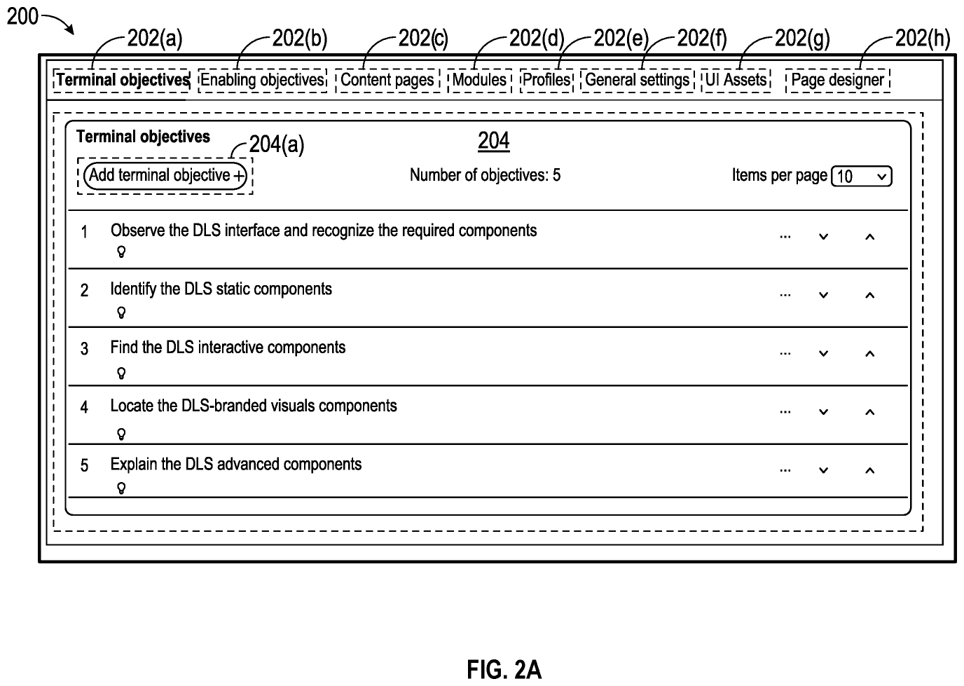

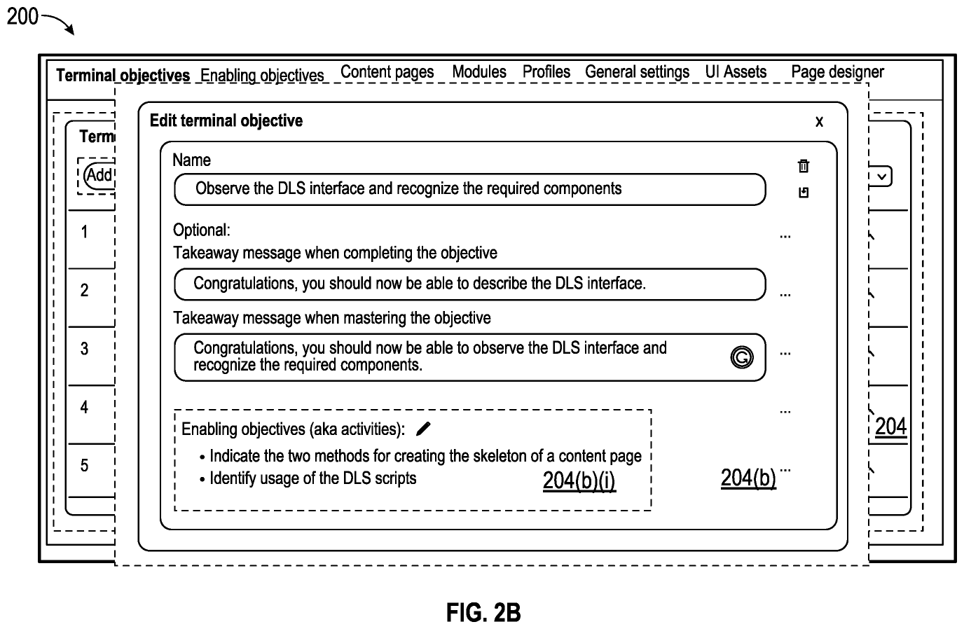

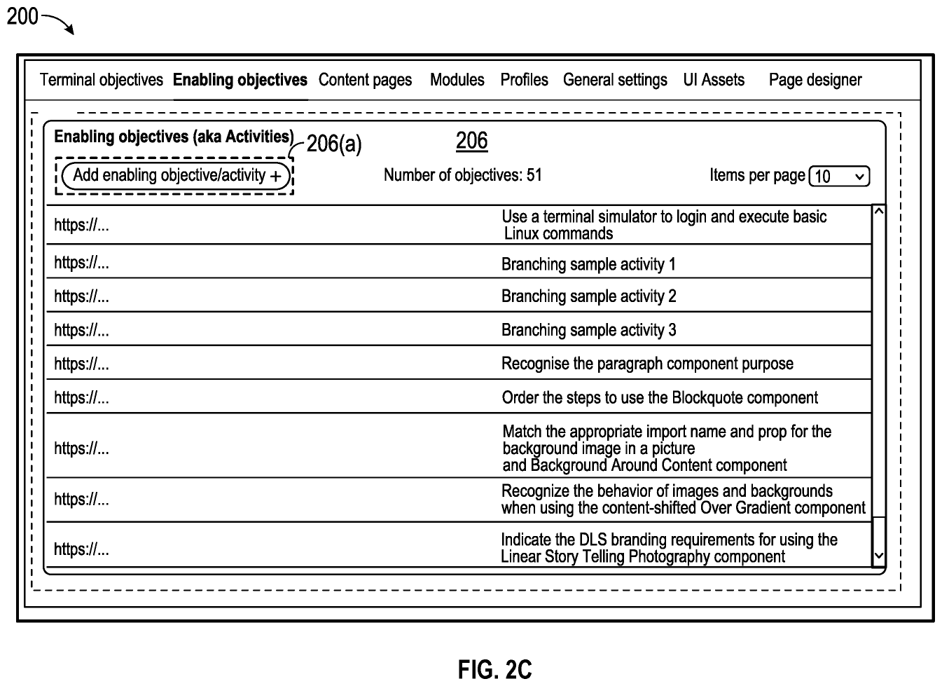

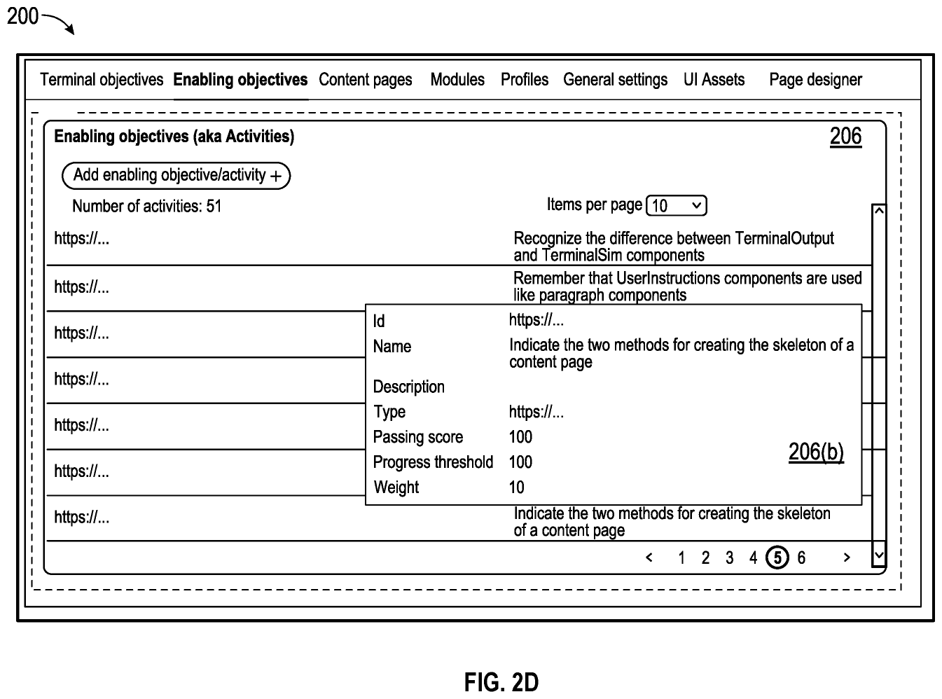

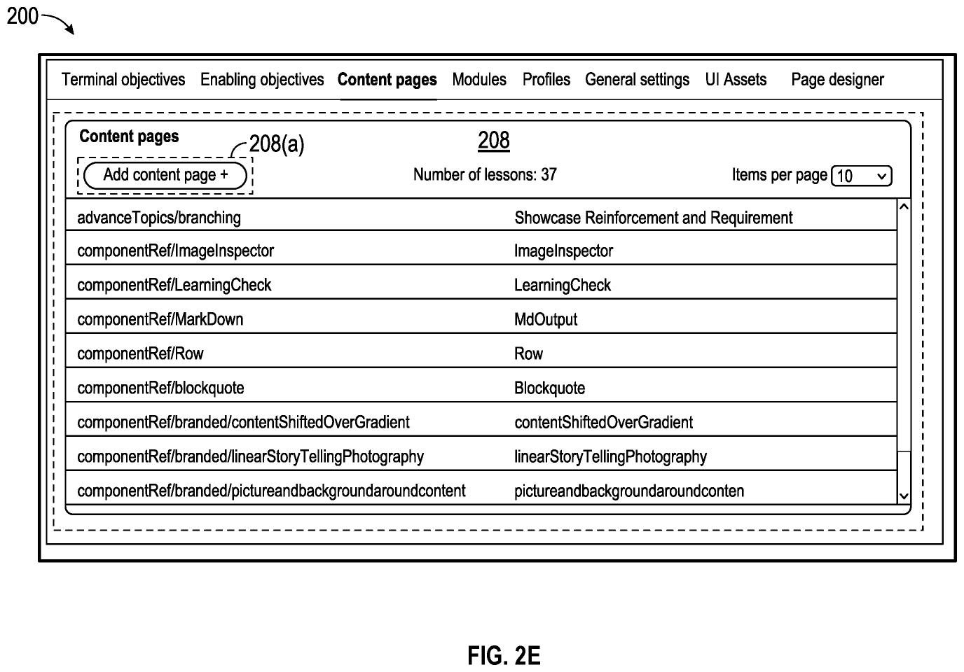

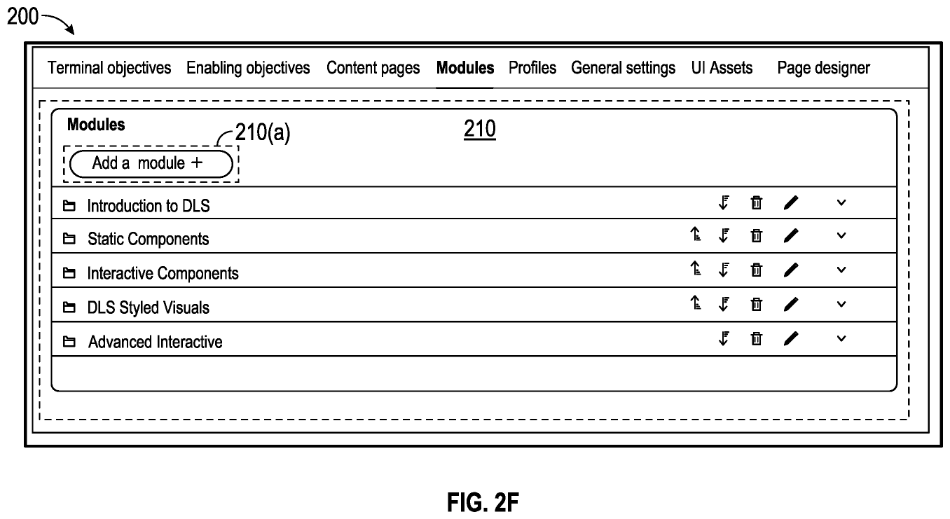

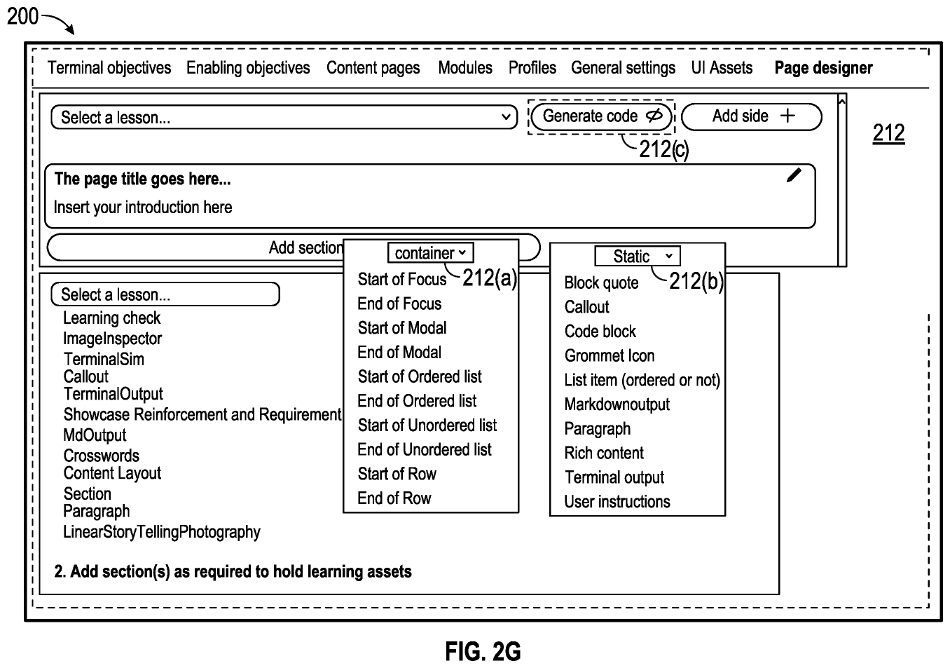

FIGS. 2A-2G depict example displays from of an author-side GUI 200 of the presently disclosed technology.

As depicted in FIG. 2A, author-side GUI 200 includes a terminal objective field 204 configured to receive low code inputs defining terminal objectives. For example, an author can use an intuitive point-and-click input/command to add a new terminal objective using icon 204(a) within terminal objective field 204. Relatedly, the author can use intuitive point-and-click inputs/commands to navigate to other fields of author-side GUI 200 using field navigation icons 202(a)-(h).

As depicted in FIG. 2B, terminal objective field 204 can include an edit terminal objective sub-field 204(b) configured to receive low code inputs (e.g., point-and-click-related inputs, drag-and-drop-related inputs, pull-down-menu-related inputs, descriptive text-entering-inputs, and other types of low code inputs) that define an terminal objective. As depicted, edit terminal objective sub-field 204(b) can also receive low code inputs that associate/bind enabling objectives to the terminal objective. Namely, an author can associate/bind enabling objectives to the terminal objective using an enabling objective association sub-field 204(b) (i) within edit terminal objective sub-field 204(b).

As depicted in FIG. 20, author-side GUI 200 can also include an enabling objective field 206 configured to receive low code inputs defining enabling objectives. For example, an author can use an intuitive point-and-click input/command to add a new enabling objective using icon 206 (a) within enabling objective field 206. Enabling objective field 206 may also display enabling objectives which an author has already defined such as: (1) Use a terminal simulator to login and execute basic Linux commands; (2) a Branching sample activity 1; (3) a Branching sample activity 2; (4) a Branching sample activity 3; (5) Recognise the paragraph component purpose; (6) Order the steps to use the Blockquote component; (7) Match the appropriate import name and prop for the background image in a picture and Background Around Content component; (8) Recognize the behavior images and backgrounds when using the content-shifted Over Gradient component; and (9) Indicate the DLS branding requirements for using the Linear Story Telling Photography component. Enabling objective field 206 may also display website links associated with each enabling objective which an author can point-and-click to be directed to one or more content pages across which a respective enabling objective is arranged.

As depicted in FIG. 2D, enabling objective field 206 can include an enabling objective editing sub-field 206 (b) configured to receive low code inputs defining various parameters related to an enabling objective including: (i) an Id (e.g., a unique identifier for an enabling objective); (ii) a name (e.g., a name of a enabling objective); (iii) a description (e.g., a unique description for an enabling objective); (iv) a type (e.g., an activity); (v) a passing performance score (i.e., a performance score indicating a learner has passed the enabling objective); (vi) a passing progress score (i.e., a progress score indicating a learner has passed the enabling objective); and (vii) a weight. This weight may be used to compute a progress and performance score for a terminal objective associated with/bound to the enabling objective.

As depicted in FIG. 2E, author-side GUI 200 can also include a content page field 208 configured to receive low code inputs defining content pages for arranging digital learning content for the enabling objectives of the digital learning course. The components shown in FIG. 2E include example names and descriptions for author-defined content pages. For example, an author can utilize an intuitive point-and-click input/command to add a new content page using icon 208 (a) within content page field 204.

As depicted in FIG. 2F, author-side GUI 200 can also include a module field 210 configured to receive low code inputs defining modules for the digital learning course. The modules may provide an author with another option for arranging the digital learning course in addition to the terminal/enabling objectives and content pages. As depicted, the author can use an intuitive point-and-click input/command to add a new module using icon 210 (a) within module field 210.

As depicted in FIG. 2G, author-side GUI 200 can also include a page designer field 212 configured to receive low code inputs defining how digital learning content is presented to learners. As depicted, this may involve designing layouts for the web pages (or segments of web pages) that contain/display the content pages. As depicted, page designer field 212 includes pull-down icons 212 (a) and 212 (b) that an author can utilize to select different layout/presentation options. As depicted, page designer field 212 also includes a generate code icon 212 (c) that allows the author to automatically create/instantiate designed web pages, and/or the entire defined/arranged digital learning course.

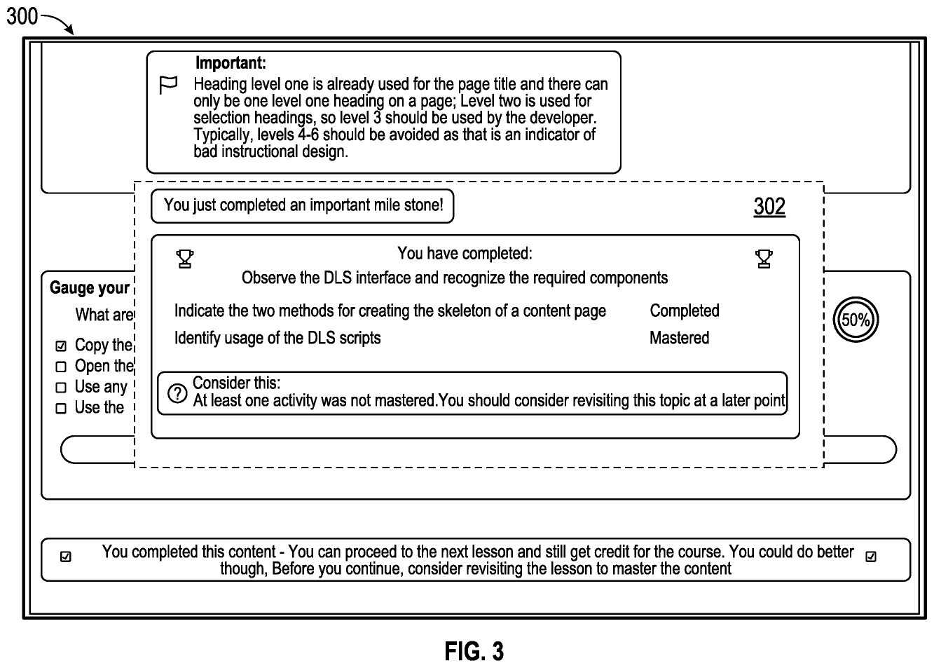

FIG. 3 depicts an example display from a learner-side GUI 300 of the presently disclosed technology.

As depicted, learner-side GUI 300 presents a learning progress update 302 to a learner. Learning progress update 302 informs the learner that the learner has completed the terminal objective titled “Observe the DLS interface and recognize required components.” Learning progress update 302 also informs the learner that a first enabling objective associated with/bound to the terminal objective-titled “Indicate the two methods for creating the skeleton of a content page”—has been completed. However, because this first enabling objective has not been mastered, learning progress update 302 prompts the learner to “consider revisiting this topic at a later point.” Learning progress update 302 also informs the learner that the learner has mastered a second enabling objective-titled “Identify usage of the DLS scripts”-associated with/bound to the terminal objective. Here, completion and/or mastery of a terminal objective can be determined by comparing computed performance and/or progress scores for the terminal objective to corresponding “completion” and “mastery” thresholds. Such “mastery” and “completion” thresholds can be provided by an author (e.g., via author-side GUI 200) or may be determined automatically by a digital learning system of the presently disclosed technology.

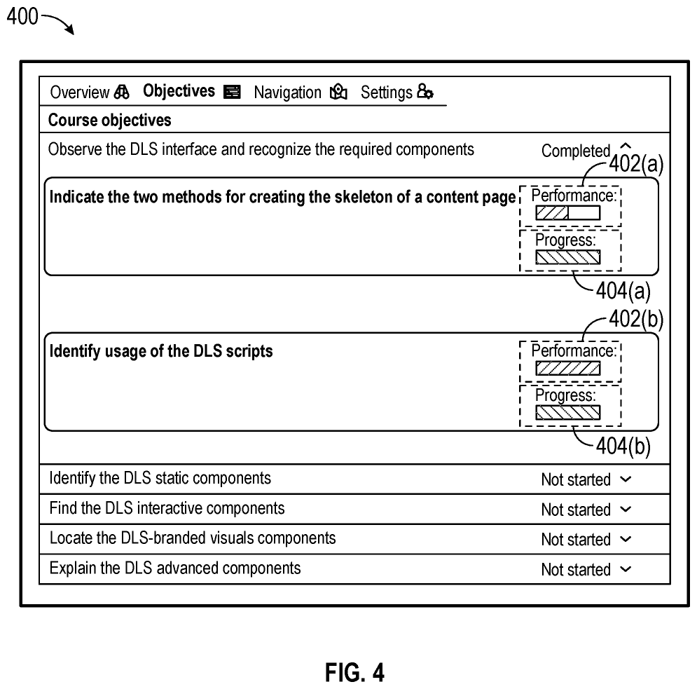

FIG. 4 depicts an display from an example learner-side GUI 400 of the presently disclosed technology.

As depicted, learner-side GUI 400 allows a learner to view their progress through the various terminal objectives of a digital learning course. The example terminal objectives are titled: (1) “Observe the DLS interface and recognize the required components;” (2) “Identify the DLS static components;” (3) “Find the DLS interactive components;” (4) “Locate the DLS-branded visual components;” and (5) “Explain the DLS advanced components.”

Examples of enabling objectives that guide learners to the first terminal objective (i.e., “Observe the DLS interface and recognize the required components”) include: (a) “Indicate the two methods for creating the skeleton of a content page;” and (b) “Identify usage of the DLS scripts.”

As depicted, the learner can view a performance score (see e.g., icons 402(a)-(b)) and a progress score (see e.g., icons 404 (a)-(b)) for the enabling objectives.

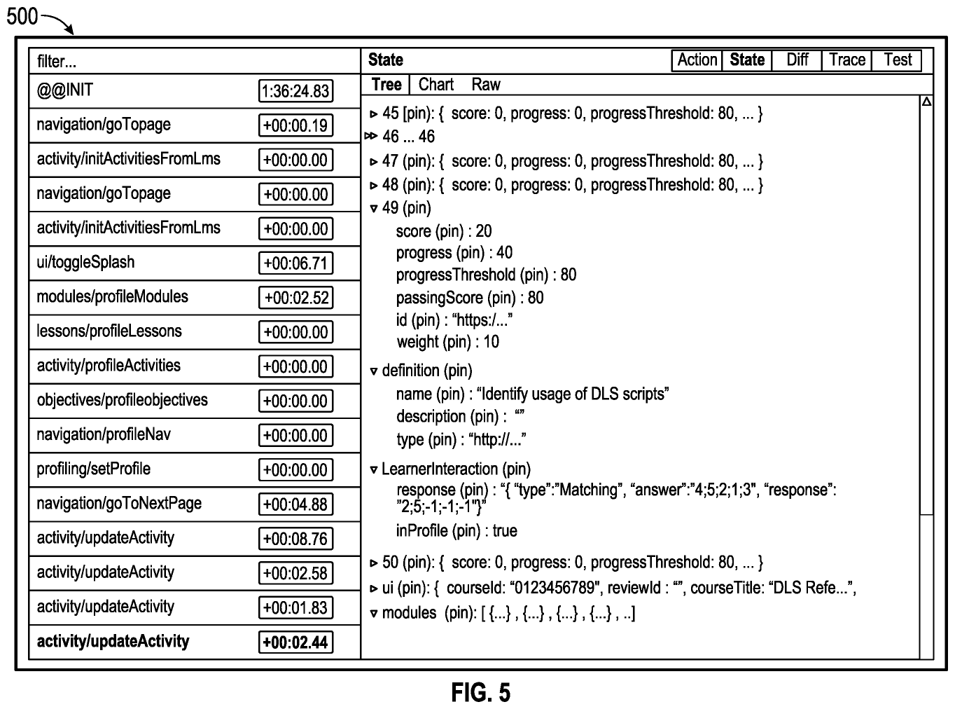

FIG. 5 depicts an example learner progress report 500, in accordance with various examples of the presently disclosed technology. Such a report may be provided via a learner-side GUI of the presently disclosed technology (e.g., one or more of learner-side GUIs 300 and 400).

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 600.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A digital learning system comprising:
one or more processing resources operative to execute machine-readable instructions to:
receive, via an author-side graphical user interface (GUI), low code inputs defining terminal objectives and enabling objectives for a digital learning course;
receive, via the author-side GUI, low code inputs defining weighted associations between a first terminal objective and a first subset of enabling objectives that guide learners toward the first terminal objective;
based on the received low code inputs, create the digital learning course comprising the defined terminal objectives and the defined enabling objectives; and
provide, via a learner-side GUI, the created digital learning course.

2. The digital learning system of claim 1, wherein the low code inputs comprise at least one of drag-and-drop-related inputs, pull-down-menu-related inputs, and point-and-click-related inputs.

3. The digital learning system of claim 1, wherein:
the terminal objectives comprise desired outcomes for learners engaging with the digital learning course; and
the enabling objectives comprise learning experiences that guide learners towards the terminal objectives.

4. The digital learning system of claim 1, wherein the one or more processing resources are further operative to execute machine-readable instructions to:
receive, via the learner-side GUI, inputs from a learner as the learner engages with the created digital learning course; and
responsive to the learner's inputs, compute a progress score and a performance score for the learner's progress towards the first terminal objective.

5. The digital learning system of claim 4, wherein computing the progress score and the performance score for the first terminal objective comprises:
computing, for enabling objectives of the first subset of enabling objectives, a progress score and a performance score for the learner's progress towards the enabling objective;
based on the weighted associations between the first terminal objective and the first subset of enabling objectives, computing the progress score for the learner's progress towards the first terminal objective as a weighted sum of the computed progress scores for the learner's progress towards the first subset of enabling objectives; and
based on the weighted associations between the first terminal objective and the first subset of enabling objectives, computing the performance score for the learner's progress towards the first terminal objective as a weighted sum of the computed performance scores for the learner's progress towards the first subset of enabling objectives.

6. The digital learning system of claim 4, wherein the one or more processing resources are further operative to execute machine-readable instructions to:
transmit, to a back-end learning management system, records related to the computed progress score and the computed performance score for the learner's progress towards the first terminal objective.

7. The digital learning system of claim 4, wherein the one or more processing resources are further operative to execute machine-readable instructions to:
responsive to at least one of the computed progress score and the computed performance score for the learner's progress towards the first terminal objective, modify content of the digital learning course provided to the learner via the learner-side GUI.

8. The digital learning system of claim 1, wherein:
the one or more processing resources are further operative to execute machine-readable instructions to receive, via the author-side GUI, low code inputs defining content pages that arrange digital learning content for the enabling objectives; and
creating the digital learning course based on the received low code inputs comprises implementing the content pages as web pages or segments of web pages provided via the learner-side GUI.

9. A digital learning system comprising:
an author-side graphical user interface (GUI) comprising:
a terminal objective field configured to receive low code inputs defining terminal objectives for a digital learning course,
an enabling objective field configured to receive low code inputs defining enabling objectives for the digital learning course, and
a content page field configured to receive low code inputs arranging digital learning content for the enabling objectives;
one or more processing resources operative to execute machine-readable instructions to:
based on low code inputs received via the author-side GUI, create the digital learning course having the defined terminal objectives, the defined enabling objectives, and the arranged digital learning content; and
provide the created digital learning course to learners via a learner-side GUI; and
the learner-side GUI configured to display the created digital learning course and receive inputs from learners as the learners engage with the created digital learning course.

10. The digital learning system of claim 9, wherein:
the terminal objectives comprise desired outcomes for learners engaging with the created learning course;
the enabling objectives comprise learning experiences that guide learners towards the terminal objectives; and
at least one of the terminal objective field and the enabling objective field is configured to receive low code inputs defining weighted associations between a first terminal objective and a first subset of enabling objectives that guide learners towards the first terminal objective.

11. The digital learning system of claim 10, wherein the one or more processing resources are further operative to execute machine-readable instructions to:
responsive to a learner's inputs received via the learner-side GUI, compute a progress score and a performance score for the learner's progress towards the first terminal objective.

12. The digital learning system of claim 11, wherein computing the progress score and the performance score for the first terminal objective comprises:
computing, for enabling objectives of the first subset of enabling objectives, a progress score and a performance score for the learner's progress towards the enabling objective;
based on the weighted associations between the first terminal objective and the first subset of enabling objectives, computing the progress score for the learner's progress towards the first terminal objective as a weighted sum of the computed progress scores for the learner's progress towards the first subset of enabling objectives; and
based on the weighted associations between the first terminal objective and the first subset of enabling objectives, computing the performance score for the learner's progress towards the first terminal objective as a weighted sum of the computed performance scores for the learner's progress towards the first subset of enabling objectives.

13. The digital learning system of claim 11, wherein the one or more processing resources are further operative to execute machine-readable instructions to:
transmit, to a back-end learning management system, records related to the computed progress score and the computed performance score for the learner's progress towards the first terminal objective.

14. The digital learning system of claim 11, wherein the one or more processing resources are further operative to execute machine-readable instructions to:
responsive to at least one of the computed progress score and the computed performance score for the learner's progress towards the first terminal objective, modify content of the digital learning course provided to the learner.

15. A method comprising:
receiving, via an author-side graphical user interface (GUI), low code inputs defining terminal objectives and enabling objectives for a digital learning course;
receiving, via the author-side GUI, low code inputs defining weighted associations between a first terminal objective and a first subset of enabling objectives that guide learners toward the first terminal objective;
based on the received low code inputs, creating the digital learning course comprising the defined terminal objectives and the defined enabling objectives; and
providing, via a learner-side GUI, the created digital learning course.

16. The method of claim 15, wherein:
the terminal objectives comprise desired outcomes for learners engaging with the digital learning course; and
the enabling objectives comprise learning experiences that guide learners towards the terminal objectives.

17. The method of claim 15, further comprising:
receiving, via the learner-side GUI, inputs from a learner as the learner engages with the created digital learning course; and
responsive to the learner's inputs, computing a progress score and a performance score for the learner's progress towards the first terminal objective.

18. The method of claim 17, wherein computing the progress score and the performance score for the first terminal objective comprises:
computing, for enabling objectives of the first subset of enabling objectives, a progress score and a performance score for the learner's progress towards the enabling objective;
based on the weighted associations between the first terminal objective and the first subset of enabling objectives, computing the progress score for the learner's progress towards the first terminal objective as a weighted sum of the computed progress scores for the learner's progress towards the first subset of enabling objectives; and
based on the weighted associations between the first terminal objective and the first subset of enabling objectives, computing the performance score for the learner's progress towards the first terminal objective as a weighted sum of the computed performance scores for the learner's progress towards the first subset of enabling objectives.

19. The method of claim 17, further comprising:
responsive to at least one of the computed progress score and the computed performance score for the learner's progress towards the first terminal objective, modifying content of the digital learning course provided to the learner.

20. The method of claim 17, further comprising:
transmitting, to a back-end learning management system, records related to the computed progress score and the computed performance score for the learner's progress towards the first terminal objective.
